(19) United States
(12) Patent Application Publication
(10) Pub. No.: US 2005/0148486 A1
(43) Pub. Date: Jul. 7, 2005

(54) LAUNDRY DETERGENT COMPOSITION CONTAINING A VIOLET COLORANT

(76) Inventors: Charles John Schramm JR., Hillsborough, NJ (US); Rosanna Oesterle McMichael, Flanders, NJ (US); Cheryl Ann Babo, Parlin, NJ (US)

Correspondence Address: Colgate-Palmolive Company, 909 River Road, P.O. Box 1343, Piscataway, NJ, 08855-1343, US

(21) Appl. No.: 10/752,344

(22) Filed: Jan. 6, 2004

(51) Int. Cl. C11D 17/00

(52) U.S. Cl. 510/419

(57) ABSTRACT

A laundry detergent composition and method of providing whitening benefits is described for providing enhanced whitening benefits to washed laundry comprising: (a) a surfactant or surfactant mixture selected from the group consisting of anionic and nonionic surfactants; and (b) a violet polymeric colorant having an absorption wavelength of from 540 to 560 nm; a solubility in water of from about 1 gram per Liter to 20.5 grams per Liter; and wherein the dosage of said violet colorant in the laundry detergent composition is from about 0.006% to about 1.75%.

This invention relates to laundry detergent compositions which provide enhanced whitening benefits to washed laundry. More particularly, this invention relates to laundry detergent compositions containing a violet colorant which reflects violet light and which is capable of being deposited on the surface of washed fabrics to provide a whitening effect or benefit.

### BACKGROUND OF THE INVENTION

The use of optical brighteners and blueing agents in detergent compositions is known to improve the perceived visual whiteness of white fabrics. Typical blueing agents have an absorption wavelength of 580-620 nm which gives a true blue color. Optical brighteners, sometimes referred to as fluorescent dyes, absorb invisible ultraviolet light and emit light in the blue region of the visible spectrum. The average person appears to favor white articles such as washed fabrics, which have a slight blue cast to them. Hence, optical brighteners have been conventionally used in laundry detergents for whitening fabrics.

But, the problem encountered with the use of blueing agents in detergent products is that when used in too great an amount, the white fabrics appear blue; and when used in an insufficient amount, they are ineffective for making the white fabric appear visually whiter. U.S. Pat. No. 3,755,201 describes a laundry product containing a mixture of dyes, one of which is referred to as Dye K corresponding to a dye marketed by Geigy Corp. under the tradename C.I. Direct Violet 66. However, the proportion of such dye in the detergent composition is said to be from 0.0001 to 0.004 percent, an amount considered too low by the standards of the present invention to deposit on washed fabrics and provide an effective blue cast to washed white articles.

U.S. Pat. No. 6,541,437 discloses speckled detergent compositions which comprise glassy phosphates colored with a dye and/or a pigment. Among the conventional dyes suitable for the described use are polymeric colorants such as Liquitint available commercially from Milliken Chemical. Conventional dyes being those dyes which are used to produce a colored speckle not a speckle that provides functional fabric benefits such as bleaching or whitening.

Accordingly, while various blue and violet dyes have been disclosed in the prior art as components of a detergent composition, there remains a need in the art for improving and enhancing the whitening benefits capable of being provided to fabrics laundered with commercial liquid and powder detergent compositions which contain conventional blueing agents or dyes.

### SUMMARY OF THE INVENTION

In accordance with the present invention there is provided a laundry detergent composition for providing enhanced whitening benefits to washed laundry comprising:
(a) a surfactant or surfactant mixture selected from the group consisting of anionic and nonionic surfactants; and
(b) a violet polymeric colorant having an absorption wavelength of from 540 to 560 nm; a solubility in water of from about 1 gram per Liter to 20.5 grams per Liter; and wherein the dosage of said violet colorant in the laundry detergent composition is from about 0.006% to about 1.75%, preferably from about 0.015% to about 0.15%.

In accordance with the process of the invention, laundering of stained or soiled fabrics is effected by washing the fabrics to be laundered in an aqueous wash solution containing an effective amount of the above-described laundry detergent composition.

The present invention is predicated on the discovery that the incorporation of a violet colorant as defined herein in a detergent composition at the defined dosage is capable of being deposited on washed fabrics to provide a whitening benefit to white articles.

### DETAILED DESCRIPTION OF THE INVENTION

Any suitable nonionic detergent compound may be used as a surfactant in the present laundry detergent compositions, with many members thereof being described in the various annual issues of Detergents and Emulsifiers, by John W. McCutcheon. Such volumes give chemical formulas and trade names for commercial nonionic detergents marketed in the United States, and substantially all of such detergents can be employed in the present compositions. However, it is highly preferred that such nonionic detergent be a condensation product of ethylene oxide and higher fatty alcohol (although instead of the higher fatty alcohol, higher fatty acids and alkyl [octyl, nonyl and isooctyl] phenols may also be employed). The higher fatty moieties, such as the alkyls, of such alcohols and resulting condensation products, will normally be linear, of 10 to 18 carbon atoms, preferably of 10 to 16 carbon atoms, more preferably of 12 to 15 carbon atoms and sometimes most preferably of 12 to 14 carbon atoms. Because such fatty alcohols are normally available commercially only as mixtures, the numbers of carbon atoms given are necessarily averages but in some instances the ranges of numbers of carbon atoms may be actual limits for the alcohols employed and for the corresponding alkyls.

The ethylene oxide (EtO) contents of the nonionic detergents will normally be in the range of 3 to 15 moles of EtO per mole of higher fatty alcohol, although as much as 20 moles of EtO may be present. Preferably such EtO content will be 3 to 10 moles and more preferably it will be 6 to 7 moles, e.g., 6.5 or 7 moles per mole of higher fatty alcohol (and per mole of nonionic detergent). As with the higher fatty alcohol, the polyethoxylate limits given are also limits on the averages of the numbers of EtO groups present in the condensation product. Examples of suitable nonionic detergents include those sold by Shell Chemical Company under the trademark Neodol®, including Neodol 25-7, Neodol 23-6.5 and Neodol 25-3.

Other useful nonionic detergent compounds include the alkylpolyglycoside and alkylpolysaccharide surfactants, which are well known and extensively described in the art.

The detergent composition may contain a linear alkyl benzene sulfonate anionic surfactant wherein the alkyl radical contains from about 10 to 16 carbon atoms in a straight or branched chain and preferably 12 to 15 carbon atoms. Examples of suitable synthetic anionic surfactants are sodium and potassium alkyl (C₄-C₂₀) benzene sulfonates, particularly sodium linear secondary alkyl (C₁₀-C₁₅) benzene sulfonates.

Other suitable anionic detergents which are optionally included in the present liquid detergent compositions are the sulfated ethoxylated higher fatty alcohols of the formula RO(C₂H₄O)ₘSO₃M, wherein R is a fatty alkyl of from 10 to 18 carbon atoms, m is from 2 to 6 (preferably having a value from about ⅕ to ½ the number of carbon atoms in R) and M is a solubilizing salt-forming cation, such as an alkali metal, ammonium, or a higher alkyl benzene sulfonate wherein the higher alkyl is of 10 to 15 carbon atoms. The proportion of ethylene oxide in the polyethoxylated higher alkanol sulfate is generally from 1 to 11 ethylene oxide groups and preferably 2 to 5 moles of ethylene oxide groups per mole of anionic detergent, with three moles being most preferred, especially when the higher alkanol is of 11 to 15 carbon atoms.

The most highly preferred water-soluble anionic detergent compounds are the ammonium and substituted ammonium (such as mono, di and tri ethanolamine), alkali metal (such as, sodium and potassium) and alkaline earth metal (such as, calcium and magnesium) salts of the higher alkyl benzene sulfonates, and higher alkyl sulfates.

The compositions of the invention are preferably free of a nonionic surfactant for purposes of enhancing the stability of the structured liquids.

Builder materials are essential components of the liquid detergent compositions of the present invention. In particular, from about 2% to about 15% of an alkali metal carbonate, such as sodium carbonate, and preferably from about 3% to about 10%, by weight.

A phosphate builder, and in particular an alkali metal (sodium) polyphosphate in an amount of from about 5% to about 30%, by weight, is an integral component of the present liquid detergent compositions. The amount of such polyphosphate builder is preferably from about 8% to about 20%.

Examples of suitable phosphorous-containing inorganic detergency builders include the water-soluble salts, especially alkali metalpyrophosphates, orthophosphates, and polyphosphates. Specific examples of inorganic phosphate builders include sodium and potasium tripolyphosphates, phosphates and hexametaphosphates.

Zeolite A-type aluminosilicate builder, usually hydrated, may optionally be included in the compositions of the invention. Hydrated zeolites X and Y may be useful too, as may be naturally occurring zeolites that can act as detergent builders. Of the various zeolite A products, zeolite 4A, a type of zeolite molecule wherein the pore size is about 4 Angstroms, is often preferred. This type of zeolite is well known in the art and methods for its manufacture are described in the art such as in U.S. Pat. No. 3,114,603.

The zeolite builders are generally of the formula
(Na₂O)ₓ.(Al₂O₃)_{y}.(SiO₂)_{z}.w H₂O
wherein x is 1, y is from 0.8 to 1.2, preferably about 1, z is from 1.5 to 3.5, preferably 2 or 3 or about 2, and w is from 0 to 9, preferably 2.5 to 6. The crystalline types of zeolite which may be employed herein include those described in “Zeolite Molecular Series” by Donald Breck, published in 1974 by John Wiley & Sons, typical commercially available zeolites being listed in Table 9.6 at pages 747-749 of the text, such Table being incorporated herein by reference.

The zeolite builder should be a univalent cation exchanging zeolite, i.e., it should be aluminosilicate of a univalent cation such as sodium, potassium, lithium (when practicable) or other alkali metal, or ammonium. A zeolite having an alkali metal cation, especially sodium, is most preferred, as is indicated in the formula shown above. The zeolites employed may be characterized as having a high exchange capacity for calcium ion, which is normally from about 200 to 400 or more milligram equivalents of calcium carbonate hardness per gram of the aluminosilicate, preferably 250 to 350 mg. eg./g., on an anhydrous zeolite basis. A preferred amount of zeolite is from about 8% to about 20%

Other components may be present in the detergent compositions to improve the properties and in some cases, to act as diluents or fillers. Illustrative of suitable adjuvants are enzymes to further promote cleaning of certain hard to remove stains from laundry or hard surfaces. Among enzymes, the proteolytic and amylolytic enzymes are most useful. Other useful adjuvants are foaming agents, such as lauric myristic diethanolamide, when foam is desired, and anti-foams, when desired, such as dimethyl silicone fluids. Also useful are polymers, anti-redeposition agents, bleaches, fluorescent brighteners, such as stilbene brighteners, colorants such as dyes and pigments and perfume.

Incoporating Liquitint Violet CT into a Detergent System

Liquitint Violet CT, a liquid polymeric colorant commerically available from Milliken Chemical, was first utilized as a 1% solution in water to identify it's activity as a fabric whitening agent. This solution was dosed in wash studies at the proper level to deliver the final desired wash concentration. Liquitint Violet CT is sufficiently soluble such that it can be incorporated into liquid detergent systems.

A solution of the colorant is not conveniently adaptable for consumer use in powdered detergent products. Placing the liquid polymeric colorant onto a suitable carrier and producing a post addable colored dot is more efficacious. The colored dot can then be added to any powdered detergent system. One type of colored dot may be produced by blending powdered sodium sulfate at 98% and 2% Liquitint Violet CT. The final powder is free of water. Another commercially available material of high water solubility in cold water is sodium acetate trihydrate. A 2% Liquitant Violet CT dot is effectively produced by combining Violet CT and Na Acetate Trihydrate. This mixture delivers an effective hue. Liquitint Violet CT may also be post added to a powdered detergent base to effectively deliver hue benefits. This mode of use is only acceptable when a violet colored product is desired.

Improved whitening is observed using Violet CT with all carriers, however, Na Acetate Trihydrate provides a highly soluble carrier which is effective to minimize any fabric staining.

### EXAMPLE 1

A wash load consisting of cotton and cotton-rich blends was washed with detergent and detergent containing Violet CT in ambient water. The load soaked for ½ hr followed by a wash. Additionally, the use of chlorine bleach and fabric softener was evaluated. The load was split and half dryer dried and half line dried outdoors. After 5 and 10 wash cycles, visual evaluations were conducted. A 10 member panel was asked “Which looks whiter and brighter?” Visual results are as follows:

TABLE 1
Comparison of Detergent versus Detergent
w/Violet CT - North Daylight

| | Line Dried | | Dryer Dried | |
|---|---|---|---|---|
| Wash | 5^{th} | 10^{th} | 5^{th} | 10^{th} |
| Detergent | 99% | 99% | 99% | 99% C.L. Violet CT |
| Alone | C.L. Violet | C.L. Violet | C.L. | |
| | CT | CT | Violet | |
| | | | CT | |
| Detergent + | Parity | Parity | Parity | 95% C.L. Violet CT |
| Bleach | | | | |
| Detergent + | 95% | 95% | Parity | 95% C.L. Detergent |
| Fabric | C.L. Violet | C.L. | | |
| Softener | CT | Detergent | | |
| Detergent + | Parity | Parity | Parity | Parity |
| Bleach + | | | | |
| Fabric | | | | |
| Softener | | | | |
| Violet CT | | Parity | | 95% C.L. Violet CT |
| vs. Violet | | | | |
| CT + Fabric | | | | |
| Softener | | | | |

C.L. = Confidence Level

The results showed that compared to detergent alone the use of Liquitint Violet CT with detergent significantly improved panelist perception of whiteness. This improved whiteness was also observed when rinse cycle fabric softener was used but not when liquid bleach was used in the wash. Chlorine bleach is very non specific in it's decolorizing of dyes and colorants.

### EXAMPLE 2

Evaluation of Violet CT-Detergent Base

A wash load consisting of cotton and cotton-rich blends was washed with detergent and detergent containing Violet CT in ambient water. The load soaked for ½ hr followed by a wash. The load was split and half dryer dried and half line dried outdoors. After 5 wash cycles, visual evaluations were conducted. A 10 member panel was asked “Which looks whiter and brighter?” Visual results were as follows:

TABLE 2
Comparison of Detergent vs Detergent w/Violet CT - 5 Wash Cycles

| | Line Dried | | Dryer Dried | |
|---|---|---|---|---|
| | North | Incan- | North | Incan- |
| Detergent versus | Daylight | descent | Daylight | descent |
| 1.2% Violet CT | 99% | 99% | 95% | 95% |
| Violet CT + Neodol 25-7 | C.L. | C.L. | C.L. | C.L. |
| on detergent base | Violet CT | Violet CT | Violet CT | Violet CT |
| 1.8% Violet CT | 90% | 99% | Parity | Parity |
| Violet CT + Accusol 455 | C.L. | C.L. | | |
| on detergent base | Violet CT | Violet CT | | |

C.L. = Confidence Level

This example demonstrated the whitening efficacy of Liquitint Violet CT when delivered on a colored dot consisting of standard detergent base and Liquitint Violet CT. The panel confirmed the whitening improvement compared to detergent only on line dried fabrics under both North daylight and incandescent light.

1. A laundry detergent composition for providing enhanced whitening benefits to washed laundry comprising:
(a) a surfactant or surfactant mixture selected from the group consisting of anionic and nonionic surfactants; and
(b) a violet polymeric colorant having an absorption wavelength of from 540 to 560 nm; a solubility in water of from about 1 gram per Liter to 20.5 grams per Liter; and wherein the dosage of said violet colorant in the laundry detergent composition is from about 0.006% to about 1.75%.

2. A laundry detergent composition according to claim 1 wherein the dosage of said violet colorant in the laundry composition is from about 0.015% to about 0.15%.

3. A laundry detergent composition according to claim 1 wherein said violet polymeric colorant is deposited on a particle comprising sodium acetate trihydrate.

4. A laundry detergent composition according to claim 1 which is free of glassy phosphate particles.

5. A method of providing whitening benefits to washed laundry comprising: providing an aqueous bath containing an effective amount of the laundry detergent composition of claim 1; and thereafter contacting the laundry fabrics to be washed with said aqueous bath to provide whitening benefits to the washed laundry.
